(19) United States
(12) Patent Application Publication
(10) Pub. No.: US 2024/0202901 A1
(43) Pub. Date: Jun. 20, 2024

(54) IMAGE PROCESSING OF DRONE-CAPTURED IMAGE FOR ASSET MANAGEMENT

(71) Applicant: Airtonomy, Inc., Grand Forks, ND (US)

(72) Inventor: Travis James Desell, Fairport, NY (US)

(21) Appl. No.: 18/081,945

(22) Filed: Dec. 15, 2022

(51) Int. Cl. G06T 7/00; B64C 39/02; G06T 7/70; G06V 10/75; G06V 20/10; G06V 20/17

(52) U.S. Cl. CPC G06T 7/0004; B64C 39/024; G06T 7/70; G06V 10/751; G06V 20/17; G06V 20/176; B64U 2101/26; G06T 2207/10032; G06T 2207/30184

(57) ABSTRACT

Methods, systems, and computer programs are presented for inspecting an asset using drone imagery. One method includes an operation for identifying an approximate location of an asset in an image, and for defining parameters of a mask associated with the asset in the image. The method further includes operations for performing a global optimization method to determine values for the parameters to obtain an optimized mask that corresponds to the asset in the image, and for extracting pixels of the image using the optimized mask to obtain asset pixels. The method further includes performing damage analysis for the asset based on the extracted pixels, and presenting results of the damage analysis on a display.

### TECHNICAL FIELD

The subject matter disclosed herein generally relates to methods, systems, and machine-readable storage media to utilize aerial images for asset management.

### BACKGROUND

Autonomous vehicles and Unmanned Aerial Vehicles (UAV) (drones) are collecting vast amounts of data for business purposes, such as to inspect business assets (e.g., wind turbine, power distribution, communication towers, storage tanks, avian mortality assessment), but the large amount of data may be difficult to process. For example, a large number of images can be captured, and it would take a human a large amount of time to inspect this large number of images, so automated analysis by computers is desired. Further, an inspection may involve coordinating the drone hardware, preparation activities, flight planning, traveling to the inspection site, downloading the instructions to the vehicle, gathering the data, storing the data, provide search tools for searching the data, and analyze the data to present useful insights for the business unit.

In many cases, there is knowledge about the location of an asset to be inspected, and an image is taken of the location. However, due to tolerances in the position of the asset and the location of the drone when the image was taken, the exact location of the asset within the image may vary considerably, which makes image processing complicated when looking for defects in the asset. Sometimes, a neural network may be used to process an image, but this may require significant amounts of human-annotated ground truth data to train the neural network, which is very time and resource consuming to obtain.

### BRIEF DESCRIPTION OF THE DRAWINGS

Various of the appended drawings merely illustrate example embodiments of the present disclosure and cannot be considered as limiting its scope.

FIG. 1 is a diagram illustrating a sample method for inspecting assets using an autonomous drone.

FIG. 2 is a flowchart of a method for drone data management, according to some example embodiments.

FIG. 3 is an aerial image of a solar-panel installation.

FIG. 4 is a thermal image taking by a drone for damage detection of solar panels, according to some example embodiments.

FIG. 5 shows examples of positive and negative masks, target regions for masking, and results of applying the masks, according to some example embodiments.

FIG. 6 illustrates parameters available for designing a solar string mask, according to some example embodiments.

FIGS. 7-8 illustrate the process for calculating the goodness of fit of the mask, according to some example embodiments.

FIG. 9A illustrates example parameters for perspective padding, according to some example embodiments.

FIG. 9B shows the results for the example perspective padding of FIG. 9A.

FIG. 10 illustrates the solar inference process, according to some example embodiments.

FIGS. 11-15 show an example of a particle swarm optimization, according to some example embodiments.

FIG. 16 is a flowchart of a method for asset inspection, according to some example embodiments.

FIG. 17 illustrates a sample image of a wind turbine with positive and negative masks, according to some example embodiments.

FIG. 18 illustrates a sample architecture for implementing example embodiments.

FIG. 19 is flowchart of a method for inspecting an asset using drone imagery, according to some example embodiments.

FIG. 20 is a block diagram illustrating an example of a machine upon or by which one or more example process embodiments described herein may be implemented or controlled.

### DETAILED DESCRIPTION

Example methods, systems, and computer programs are directed to inspecting an asset using drone imagery. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In one aspect, a drone-captured image is processed using one or more masks in order to detect the location of an asset within the image by using optimization methods to fit the mask to the image. Additionally, perspective correction is applied to correct for the viewing angle of the image when taken. By using masks and optimization methods, asset detection may be used without utilizing machine-learning models, which may require large amounts of training data that has to be labeled by humans, resulting in an expensive process to keep the models relevant.

One general aspect includes a method that includes operations for identifying an approximate location of an asset in an image, and for defining parameters of a mask associated with the asset in the image. The method further includes operations for performing a global optimization method to determine values for the parameters to obtain an optimized mask that corresponds to the asset in the image, and for extracting pixels of the image using the optimized mask to obtain asset pixels. The method further includes performing damage analysis for the asset based on the extracted pixels, and presenting results of the damage analysis on a display.

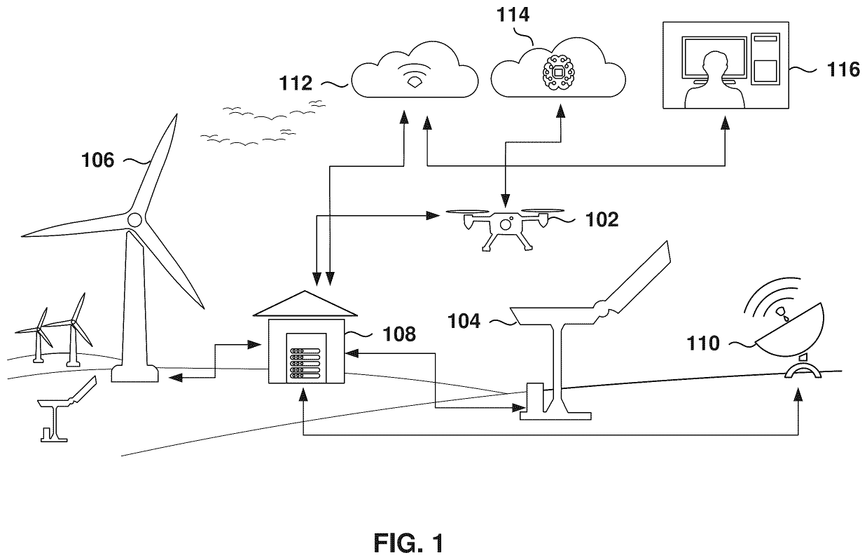

FIG. 1 illustrates a sample method for inspecting assets 106 using a drone 102. A user interfaces with a control program 116 to request autonomous inspection of assets 106, e.g., a wind turbine. A data center 108 includes electronic equipment that includes software and hardware for managing missions, storing data, analyzing the data, etc.

Additionally, cloud services 112, 114 are used for data storage and for using computer processors to analyze the data. Once the user enters the request for inspection, (e.g., communicated to the field via wireless communications 110), the drone 102 flies to the asset and captures sensor data, (e.g., images of the turbines to detect defects, images of the ground to detect dead birds, measurements of gas sensor, temperature measurements, LIDAR measurements). A housing 104 hosts the drone 102 while not in use.

After the drone 102 returns to the housing 104, the data is uploaded, such as to one of the cloud services 112, 114. Data analysis is then performed on the collected data to determine problems. For example, image processing and defect detection are performed to analyze the data in order to detect defects on the wind turbines. The results may then be observed by the user via the user interface (UI) of the control program 116.

Each mission requires an authorization before it can be executed. In some example embodiments, the operation of the drone 102 is autonomous because the mission assigned to the drone 102 includes the required parameters for the drone 102 to fly to the required asset 106, capture the necessary data (e.g., multiple pictures of sections of each of the blades), package the data, and then download the data for analysis.

It is noted that some embodiments are presented with autonomous UAVs, but the same principles may be used for other autonomous vehicles, which are referred to as robots. Further, the inspections may be many types of assets besides wind turbines, such as avian mortality assessment, or agricultural crops.

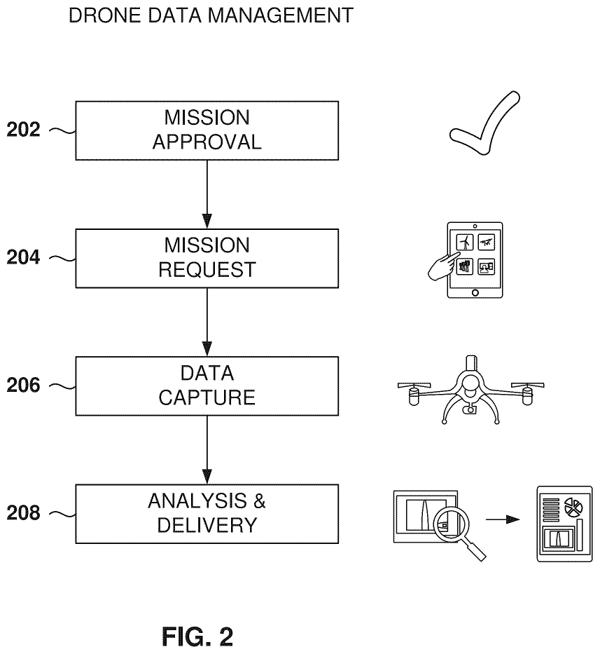

FIG. 2 is a flowchart of a method for drone data management, according to some example embodiments. The architecture for drone data management builds on use cases and enables the use of automated workflows.

At operation 202, the mission is approved. An administrator utilizes the management program to select a workflow and then entering the request. The authorization process includes approving the mission by one or more persons that have authority to enable the mission.

After the mission is approved, the method flows to operation 204 where a mission request is generated. The mission is requested by an operator on the field that is authorized to initiate the mission.

The mission is then executed by the robot that travels to the programmed location to inspect the asset and captures the data 206. After the robot ends the task, the data captured by the robot is downloaded and placed in a package that is stored on a server, such as a cloud server.

The stored data is then analyzed, and the results delivered to the user at operation 208. For example, the data may show images of a solar panel or a wind turbine and the result may be a fault on one of the panels or turbines, such as a broken panel or a crack on a turbine blade.

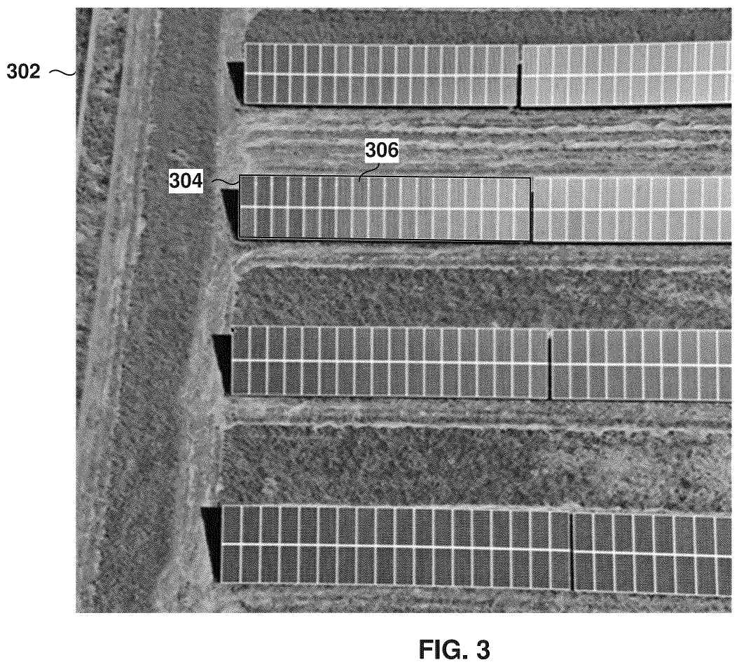

FIG. 3 is an aerial image 302 of a solar-panel installation. The installation includes several strings 304 of solar panels 306, where each string 304 includes one or more rows of solar panels. The example shows several strings 304 in a 2×18 configuration (2 rows by 19 columns).

The image 302 was captured by a drone flying on a mission to inspect the solar-panel installation. The goal of image processing is finding the details about each string, which include the location of the string 304 within the image (defined by horizontal and vertical offsets from a corner of the image) and the locations within the image of the four corners of the string 304. Since each corner location includes a horizontal and vertical value, the location of the eight corners means identifying ten different values.

Typically, the approximate location of the panel (defined by latitude and longitude) is known since the panels are in a fixed location. However, the location may not be very accurate. Also, some panels may rotate during the day depending on the position of the sun, so the position may not be static.

Further, the drone taken the image also knows its GPS location when the image was taken, which provides an approximation on the location of the strings 304. Additionally, the viewing angle of the camera when taking the image is also known.

Thus, there is a general idea of the location of the string, just by using simple geometry. However, a small lack of accuracy due to the factors identified above, may result in an incorrect offset of the string within the image. Thus, if analysis is done on the part of the image corresponding to the string 304, the analysis may fail because the wrong pixels are being analyzed. Therefore, image processing is performed on the captured image 302 to determine accurately the location of the string 304 in the image and the four corners within the string 304.

That is, in general, for troubleshooting problems for any asset using imagery, image processing is performed to obtain an accurate location of the asset within the image, and once the location is determined, defect detection may be performed to look for problems within the asset that can be detected visually (e.g., broken asset, obstructed asset, missing asset, etc.), including analysis of thermal images, color images, or black and white images.

Although some embodiments are described with reference to solar panels and turbines, the same principles may be used for any type of asset being inspected using images captured by a robot or a fixed security camera.

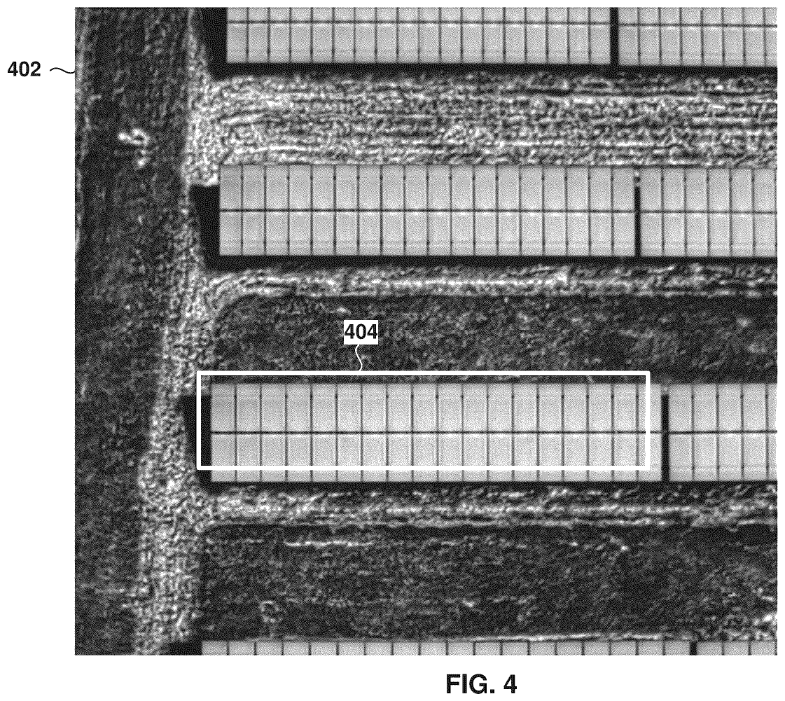

FIG. 4 is a thermal image 402 taking by a drone for damage detection of solar panels, according to some example embodiments. The image 402 covers several strings of solar panels. It can be observed that the blue areas of the solar panels appear as light grey, the frames of the solar cells appear in dark grey, and the surrounding terrain is mostly dark grey.

The goal is to identify the locations of the strings within the image 402 based on analysis of the pixels in the image 402. Although a thermal image is shown for the description of the method, or other types of images may also be used, such as black-and-white images and color images. For example, when analyzing color images, the search to locate the solar cells will be based on finding blue pixels that correspond to the solar cells, while pixels outside the solar cells will appear in other colors such as green for the grass, brown for the dirt, black or white for the frames, etc. The embodiments illustrated should therefore not be interpreted to be exclusive or limiting, but rather illustrative.

The process of identifying the exact location of the string begins with an approximate string location 404 based on the coordinates of the drone and the expected location of the string. In this example, the approximate string location 404 is slightly up and to the left of the exact location of the string in the image 402.

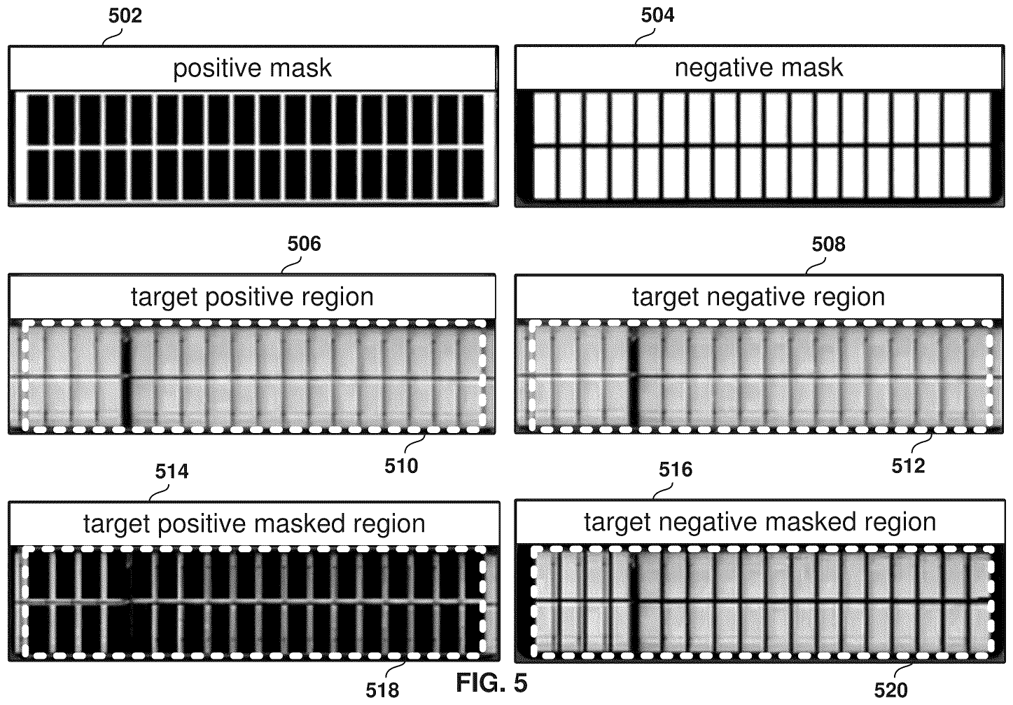

FIG. 5 shows examples of positive and negative masks, target regions for masking, and results of applying the masks, according to some example embodiments. To detect strings in thermal (or RGB) imagery, masks are used to extract pixels closer to white where the light pixels (or a particular color for RGB images) are expected, and extract pixels closer to black where the dark pixels (or another particular color for RGB images) are expected.

As used herein, a mask is a pattern in an image used to extract pixels from another image by passing through some pixels (e.g., remain unchanged) and discarding (e.g., making black or white) the rest of the pixels to obtain a masked image. In some example embodiments, the mask includes black and white pixels, where white pixels in the mask are used to keep the corresponding pixels from the processed image in the masked image, and the black pixels in the mask are used to block the corresponding pixels in the masked image, and the blocking may include replacing the blocked pixels with black pixels, although other values may be used instead, such as white pixels or some other RGB value. Other embodiments may utilize different values for the mask pixels. The embodiments illustrated in FIG. 5 should therefore not be interpreted to be exclusive or limiting, but rather illustrative.

In some example embodiments, there are two types of masks: a positive mask 502 and a negative mask 504. The positive mask 502 is to mask the thermal image (e.g., image 402, or a section thereof, of FIG. 4) to obtain the expected dark pixels in the processed image. The negative mask 504 is to mask the thermal image to obtain the expected light pixels in the processed image.

The target positive region window 506 shows the area 510 of the image 402 where the positive mask 502 is to be applied. The target positive masked region window 514 shows the results of applying the positive mask 502, which include blocked (e.g., black) pixels from the image 402 and pass-through pixels from the image 402 corresponding to the white pixels on the positive mask 502. The result is positive masked image 518.

Similarly, the target negative region window 508 shows the area 512 of the image 402 where the negative mask 504 is to be applied. The target negative masked region window 516 shows the results of applying the negative mask 504, which include blocked (e.g., black) pixels from the image 402 and pass-through pixels from the image 402 corresponding to the white pixels on the negative mask 504. The result is negative masked image 520. In some example embodiments, the mask may be applied via a bitwise logical AND operation between the corresponding pixels in the image and the mask.

Thus, the positive masked image 518 is supposed to include the dark pixels from the masked image and the negative masked image 520 is supposed to include the light pixels from the masked image. In an ideal world, the positive masked image 518 would have all dark pixels, and the negative masked image 520 would have all the light or white pixels. However, when the match is not perfect, mismatches may be observed, such as the appearance of double lines on the left side of the negative masked image 520. The goal is to find the best location of the mask that provides the best matching of light and dark pixels.

The optimization process aims at calculating ten different values corresponding to coordinates (x and y values) of five points. The first point is the best location of the mask for application on the image to be masked, and the other four points correspond to the coordinates of the four corners of the solar string. It is noted that the four corners may not be a perfect rectangle because of an angled perspective view or some distortion.

Once the five coordinates are calculated, a perspective transform is performed to transform the masked area to a rectangle, as if the image would have been taken by a camera in front of the string with a perpendicular viewing angle to the string. The process includes applying perspective distortion to find the best match. The result is a rectangular image with the pixels from the solar string. This image may then be processed for damage detection on the solar string.

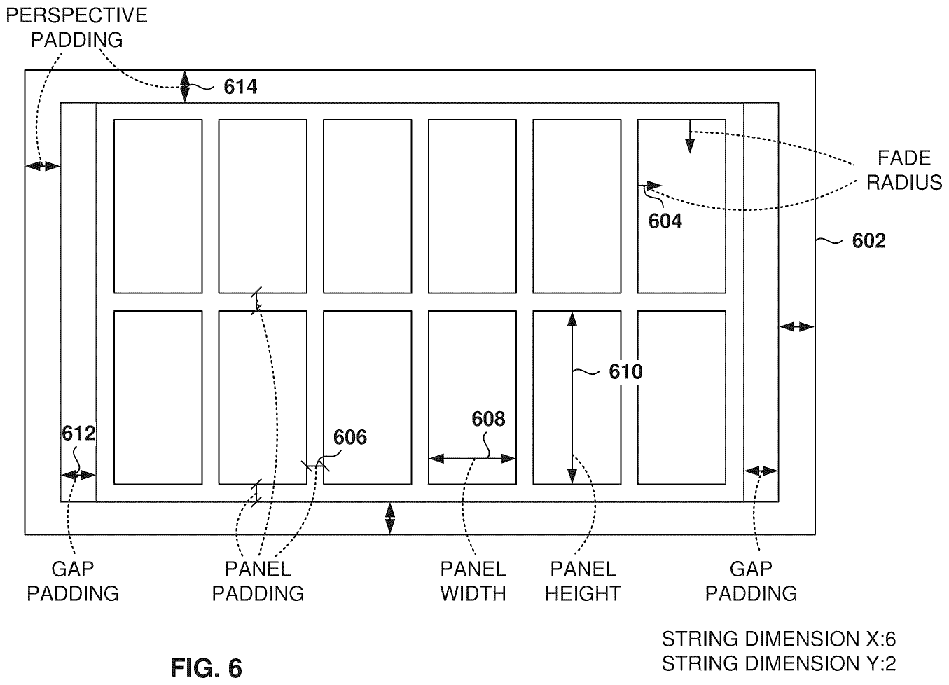

FIG. 6 illustrates the parameters available for designing a string mask 602, according to some example embodiments. In some example embodiments, several parameters can be configured to define the string mask 602:
string dimension x: width of the solar panel expressed as the number of modules (e.g., solar panels) in the horizontal direction (x is equal to six in the illustrated example);
string dimension y: height of the solar panel expressed as the number of modules (e.g., solar panels) in the vertical direction (v is equal to two in the illustrated example);
panel width 608: the width in pixels of one panel, where the pixels inside the panel are expected to be white or close to white in the image (e.g., 16 pixels). The width of the panel (e.g., measured in meters) is converted to the number of pixels in the image;
panel height 610: the height in pixels of one panel (e.g., 31 pixels). The height of the panel (e.g., measured in meters) is converted to the number of pixels in the image;
panel padding 606: number of pixels between and around panels in the mask (e.g., 1 pixel) (these pixels are expected to be black);
gap padding 612: number of pixels on the sides of the string representing the gap between strings (e.g., 5 pixels) (these pixels are expected to be black);
fade radius 604: rate of change (e.g., how quickly) to fade in from the black module padding to the white inside modules (e.g., radius of 8 pixels);
having the fade radius 604 makes the models, for searching the best fit of the mask, easier to optimize because the search space is smoother; and
perspective padding 614: provides extra padding (e.g., 4 pixels) around the entire mask which allows for corner adjustments when performing an optimization method (either local or global).

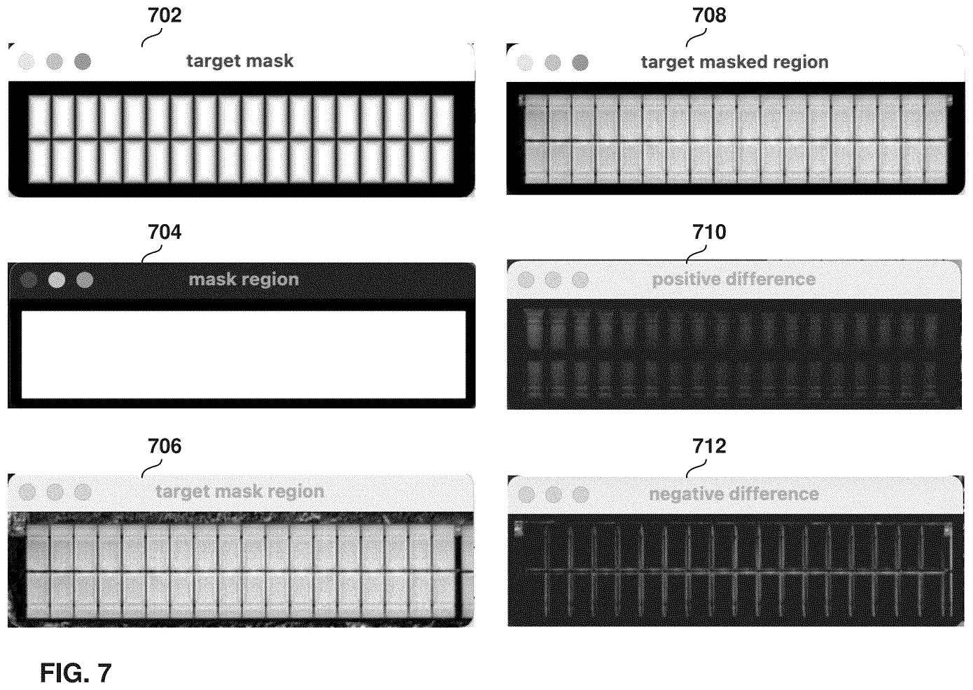

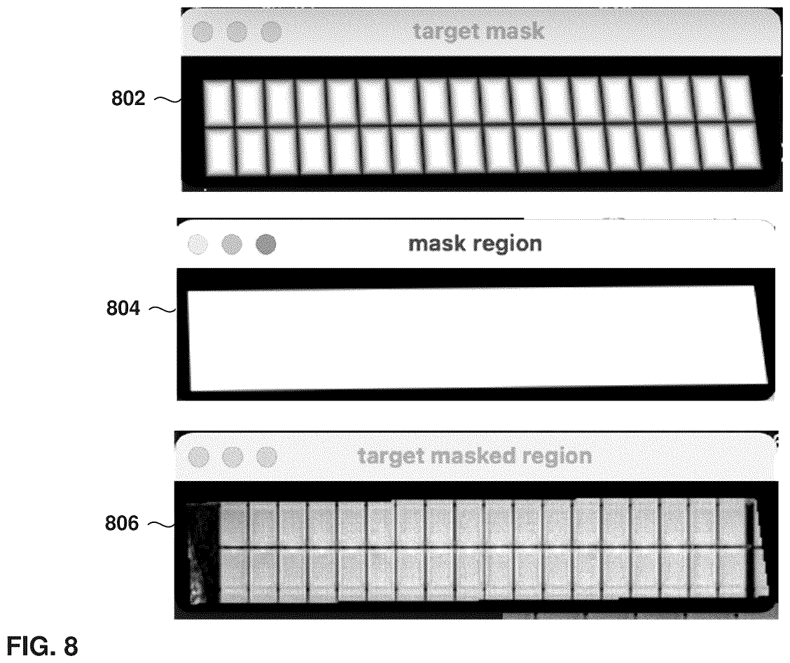

FIGS. 7-8 illustrate the process for calculating the goodness of fit of the mask, according to some example embodiments. The target mask 702 of FIG. 7 is an example of the mask created with the values presented above with reference to FIG. 6. The additional padding around the panels allows for perspective deformations during optimization.

In addition, a mask region 704 is generated to extract the target area in the target image which can be used as a binary mask. The mask region 704 includes the black gap padding pixels (but not the extra perspective padding pixels 614), used to extract the region of the image to compare against the mask.

Target mask region 706 is the area of interest in the thermal image. Target masked region 708 is the result of performing a bitwise between the target mask region 706 and the mask region 704 to get the pixels of interest.

The pixels in the target masked region 708 can then be subtracted from the pixels in the target mask 702. In some example embodiments, a sum of squared distance between the mask and target region is used; however, with less pixels that should be blacker, capturing these lines between panels is important for accurately capturing the string and panel positions. Because of this, it is possible to separate into pixels values which were less than the mask (should have been more white/positive difference) to obtain the positive difference 710, and pixels that were greater than the mask (should have been more black/negative difference) to obtain the negative difference 712.

The distance for the pixels that should have been blacker and the pixels that should have been whiter is calculated, and weights are assigned to the distances. For example, the distance may be calculated as the sum of the squared distance between the mask and the target pixels.

In some example embodiments, the quality of the fit of the mask (also referred to as fitness) is calculated as follows:

dm(difference matrix)=target mask−target masked region;

pd(positive difference)=sum of the squared difference of pixels greater than 0 in dm;

nd(negative difference)=sum of the squared difference of pixels less than 0 in dm;

fitness=nd·weight+pd

Here, weight is a parameter for controlling how much weight is given to pixels that should have been blacker in calculating the fitness. For example, weight is usually given a value greater than 1.

It is noted that that this process works while performing perspective transforms which simulate looking at the target region from different angles. When a perspective transform is performed, it is done both to the mask and to the mask region, which can result in nonrectangular target mask regions, such as target mask 802 in FIG. 8. Also in FIG. 8, examples of a non-rectangular mask region 804 and a non-rectangular target masked region 806 are illustrated.

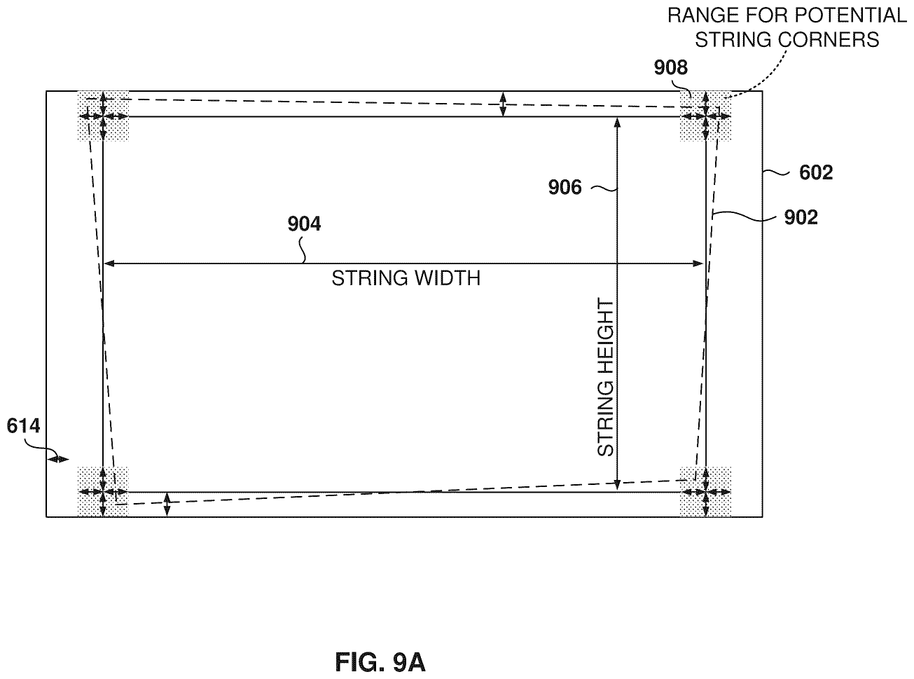

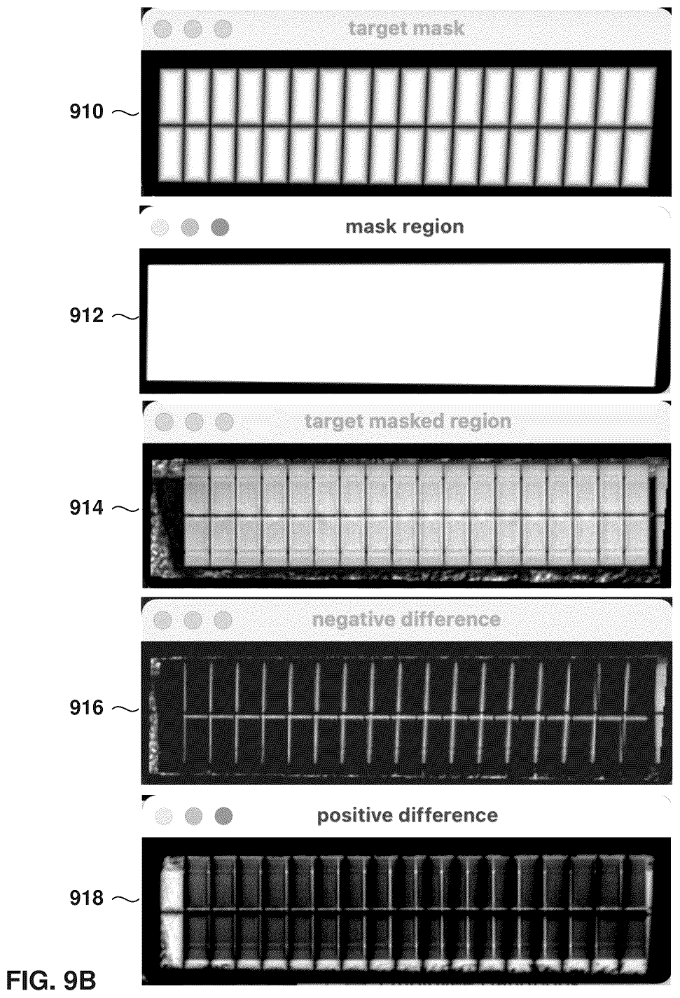

FIG. 9A illustrates example parameters for perspective padding, according to some example embodiments. The original string mask 602 is presented with a perspective transformed string 902, string width 904 (without gap padding), string height 906, and the extra perspective padding pixels 614.

Further, the range for potential corners 908 shows the area where the string corners could potentially be optimized via perspective transforms with the example transformation shown for the perspective transformed string 902.

FIG. 9B shows the results for the example perspective padding of FIG. 9A. The perspective transforms the target mask and the mask region, which can be used to extract the pixels to compare the mask against. The results include target mask 910, mask region 912, target masked region 914, negative difference 916, and positive difference 918 to compute the fitness.

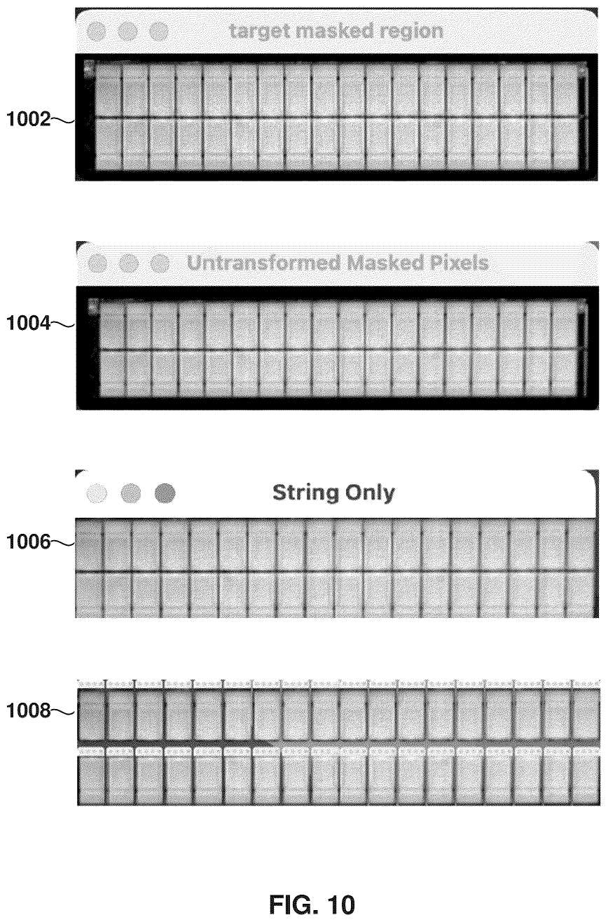

FIG. 10 illustrates the solar inference process, according to some example embodiments. The solar inference process assumes the existence of previously calculated estimates of the latitudes and longitudes of the solar string center points. Given an image and its potential latitude and longitude range, the solar inference process calculates which solar strings are contained within the image.

The process begins with the approximate string location 404 as illustrated in FIG. 4, which corresponds to the initial mask. In some example embodiments, the process to identify the location of the string includes four operations:
1. Local Search
2. String Extraction
3. Module Extraction
4. Module anomaly detection, hot spot detection, and cold spot detection.

In some example embodiments, the local search is performed with the hill-climbing method, but other search algorithms may be used. Given the rough initial placement of the mask (with no perspective distortions), a local search is performed, using hill climbing, to refine the corner points of the solar string. The optimization parameters include the following:
1. an x and a y offset (corresponding to the top right corner of the mask location);
2. a panel width adjustment and a panel height adjustment (to assist in adapting to the panel size), which allow the search to select from a range of panel widths and heights, and
3. four corner point adjustments to perform perspective transforms to the mask, which shift each of the four string corners within the mask (represented as x1/y1 for top left, x2/y2 for bottom left, x3/y3 for top right, and x4/y4 for bottom right) to allow for different camera angles when the image was taken of the solar string.

This totals 12 different parameters (x offset, y offset, panel width adjustment, panel height adjustment, x1 shift, y1 shift, x2 shift, y2 shift, x3 shift, y3 shift, x4 shift, and y4 shift) for the optimization method to determine.

The initial x and y offsets are set initially to provide the conversion from the string latitude and longitude to the pixel location, and the other parameters are set to 0.

While any local search method could be used for the mask optimization process, in some example embodiments any, or a mixture, of the following hill climbing strategies are used: deterministic hill climbing, stochastic hill climbing, and multi-stochastic hill climbing. These methods provided good performance in practice, taking just a few seconds in a laptop computer to calculate.

The deterministic hill climbing method, given a step radius, takes the current set of parameters, generates a list of potential moves, evaluates the mask fitness at each of these moves, and selects the move which most improves the mask fitness. The method terminates when there are no more move improvements for the mask fitness.

The list of potential steps is calculated for move m=1, 2, . . . N, where Nis the step radius, and m is the number of pixels difference. The steps include:
1. for each parameter, m is added to the one parameter, and then the list of parameters is added to the list (this will generate 12 moves, one for each parameter).
2. for each parameter, m is subtracted from one parameter and the list of parameters is added to the list (this will generate 12 moves, one for each parameter).
3. for each pair of parameters and for each combination of plus and minus for the pair (i.e., ++, +−, −+, ++), add or subtract m from the chosen two parameters (keeping the rest at the initial parameters) and add that to the list. This results in 12 choose 2 (66) parameter pairs with 4+/− options for a total of 264 moves.

Thus, for a step size of 3, a total of 792 moves will be evaluated for each iteration of deterministic hill climbing. In general, the deterministic hill climbing method is good for very fine local refinement but may get stuck in local optima.

The stochastic hill climbing method, given a step radius and a number of termination iterations, randomly generates a move by modifying a parameter within the range of [−step radius, +step radius]. If the fitness of the move is better than the fitness of the current parameters, the move is made, and the new parameters are set as the current parameters. If the number of termination iterations moves have been attempted without an improvement in fitness, the step radius is reduced by 1 and the process repeats. The local search terminates when the step radius reaches 0.

The stochastic hill climbing method is more robust for breaking out of local optima, but can miss out on the final refinement.

The multi-stochastic hill climbing method performs multiple stochastic hill climbing runs at the expected coordinates but also with starting points around the original coordinates. This results in more robustness against inaccuracy with the initial latitude and longitude pixel locations.

Given a x offset, a y offset, and a radius, the method performs nine stochastic hill climbing runs with the following initial x and y offsets (up, down, left, right, four corners by radius):
1. x offset, y offset
2. x offset−radius, y offset+radius
3. x offset, y offset+radius
4. x offset+radius, y offset+radius
5. x offset+radius, y offset
6. x offset+radius, y offset−radius
7. x offset, y offset−radius
8. x offset−radius, y offset−radius
9. x offset−radius, y offset

In some example embodiments, radius is usually 0.75 times the panel width, but other values may also be used. If more robustness to inaccuracy in the latitude and longitude conversion is required, the radius could be expanded in a grid with multiple steps around the original location. The best mask across all hill-climbing runs is selected to define the best fit of the mask to the solar string.

In some example embodiments, the hill-climbing methods are combined. For example, multi-stochastic hill climbing is performed first with the radius equal to 75% of the panel width. Then the multi-stochastic hill climbing is performed again with the radius equal to 25% of the panel width, and then again with the radius equal to 5% of the panel width. After, deterministic hill climbing is performed using the best parameters from the previous local search as the starting point for the next search to ensure the tightest fit of the mask to the module.

Once the optimized location of the mask over the solar string is determined, the next operation is to extract the string pixels from the image for analysis.

The target masked region 1002 is extracted from the image. The target masked region 1002 has the original corner point locations and updated corner point locations (calculated from the x1, y1, x2, y2, x3, y3, x4, and y4 shift parameters), which convert from the mask's original rectangle to the polygon which optimizes the masks fit to the region through a perspective transform calculated using the old and new corners.

The new corners can then be untransformed by calculating the perspective transform matrix from the new corners to the old corners (the opposite transform), which will transform the image such that the polygon made from the new corners is now a rectangle with the old corners as shown in the untransformed masked pixels 1004.

The image is clipped by removing the perspective and gap padding, which isolates the string as a rectangle, resulting in the pixels for string only 1006.

Then, given the extracted string only 1006, then the panel extraction is performed. With the string extracted as a rectangle, extracting the panels is a simple process by dividing up the string by the number of panels in the x and y dimensions, resulting in the extracted panels 1008. In the extracted panels 1008, the pixels for each panel are known and can be analyzed separately to find anomalies, such as broken panels, hot spots, cold spots, etc.

For anomaly detection, given a set of extracted panels from a string (or potentially a row or a hand selected set of representative set of panels), the average and standard deviation of the pixel value for each pixel in a panel are calculated. Hot and cold thresholds are configurable in the system, and each pixel in the panel is analyzed to determine if the pixel value exceeds the hot or cold threshold value.

Further, the method identifies anomalous pixels that fall outside a predetermined number N of standard deviations away from the average pixel value in the panel. If at least a configurable number M of pixels are flagged as anomalous, then the panel is flagged as having an issue and requiring human review.

For damage classification, machine-learning models may be trained to analyze each panel separately. Given enough human annotated modules to form a training set, classification models are trained to determine damage types. Additionally, simpler computer vision methods may be used to determine if there is an anomalous hot region in a damaged panel. If there are multiple damaged panels organized in specific patterns, these are flagged as high-level damages. Similarly, anomalous cold regions of various sizes and configurations can be flagged, as well as other issues such as vegetation obstruction or some other panel obstruction.

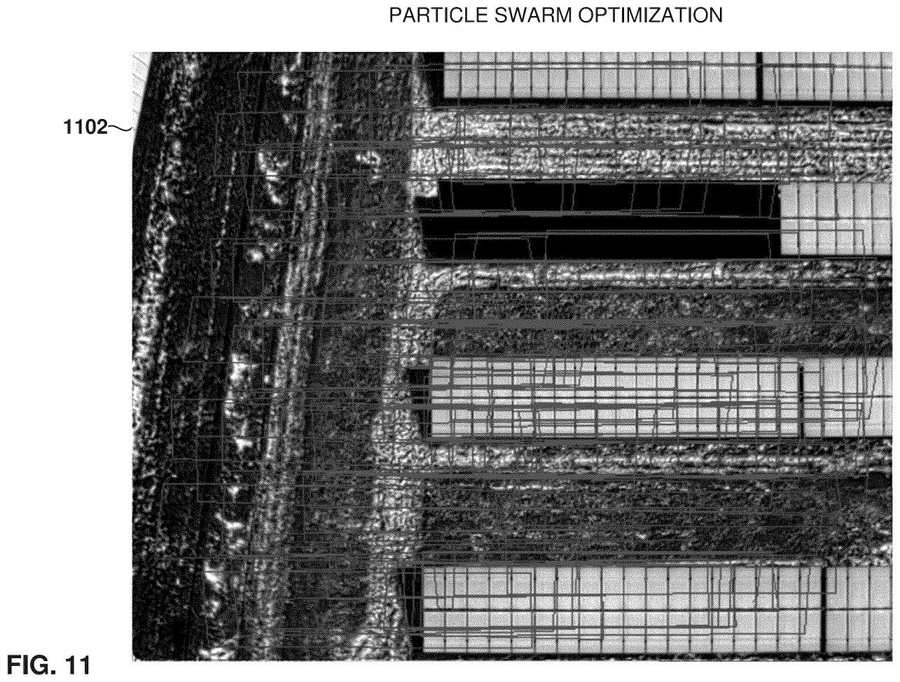

FIGS. 11-15 show an example of a particle swarm optimization, according to some example embodiments. The localization process for calculating corner points for solar strings, begins with a global optimization method (e.g., particle swarm optimization, differential evolution, CMA-ES, firefly algorithm), as discussed above, to find the best mask positions in an image. In some example embodiments, the global optimization method optimizes the 12 different parameters described above.

Particle swarm optimization (PSO) is a computational method that optimizes a problem by iteratively trying to improve a candidate solution with regard to a given measure of quality. It solves a problem by having a population of candidate solutions, here dubbed particles, and moving these particles around in the search-space according to simple mathematical formula over the particle's position and velocity. Each particle's movement is influenced by its local best known position, but it is also guided toward the best known positions in the search-space, which are updated as better positions are found by other particles. This is expected to move the swarm toward the best solutions.

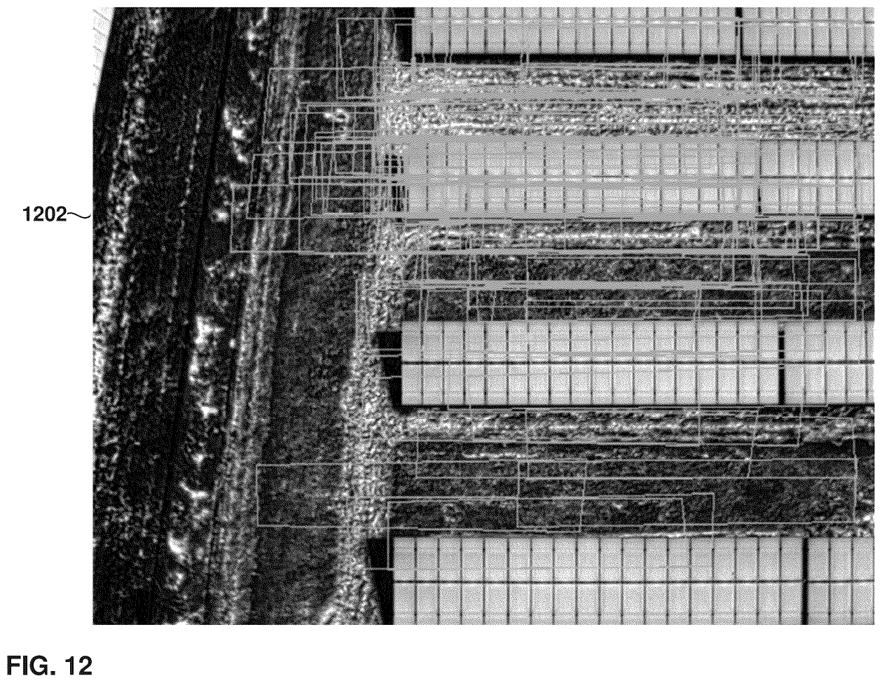

FIG. 11 shows image 1102 with the particle's best found previous position. FIG. 12 shows image 1202 with the particle's current positions.

The global search is improved by making the particles memetic and incorporating a short local search, such as hill climbing when each new potential mask position is evaluated. This locally adapts and improves the position and return the fitness and updated position for the search.

After the global search concludes, the global best found mask can be further refined by a longer running local search (hill climbing) process, as global searches tend to be overall less accurate for final refinement.

The final optimized mask is removed (blacked out) from the image and this process repeats until a user specified number of strings have been extracted from the image.

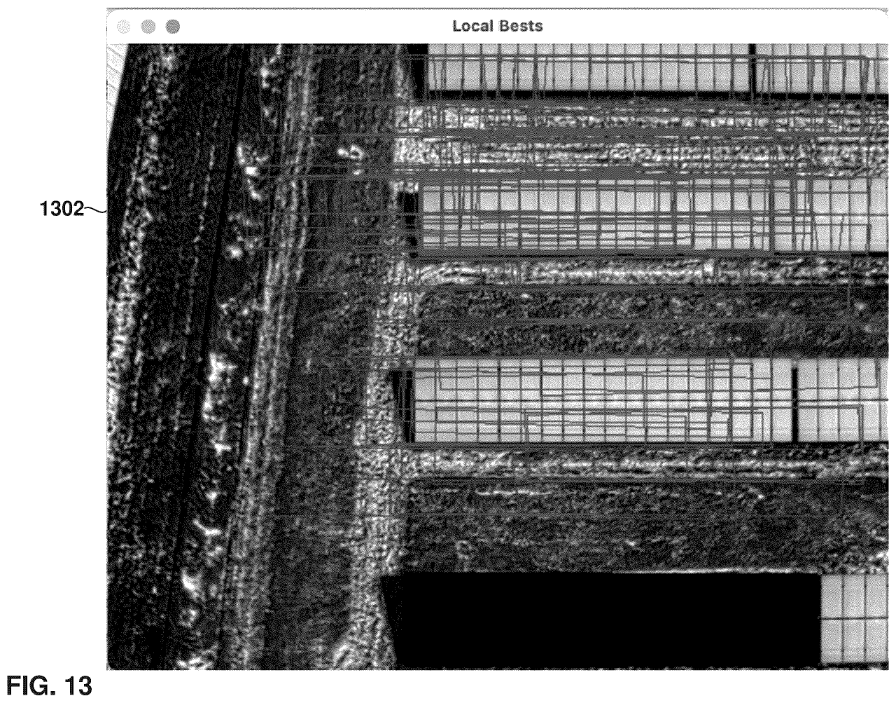

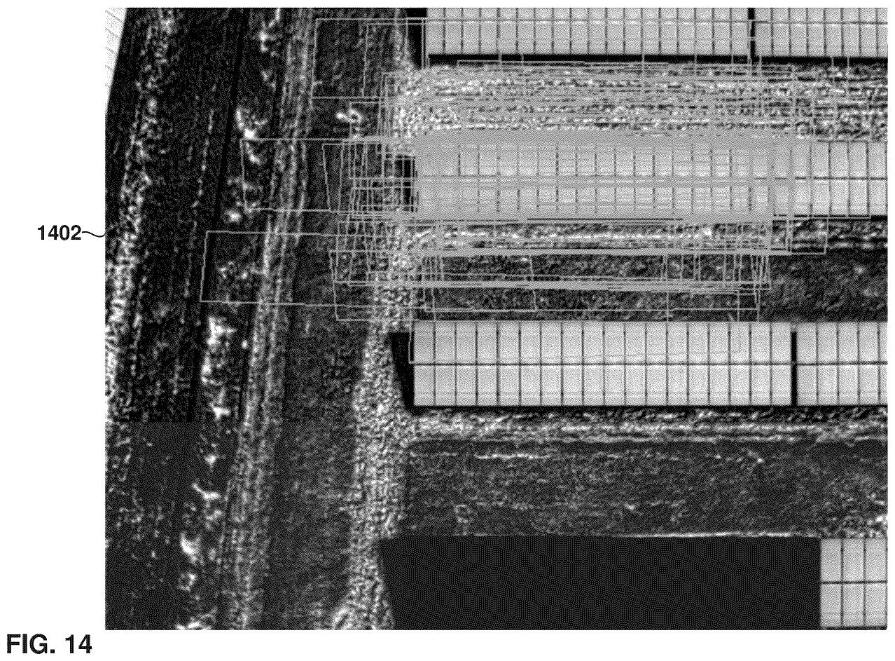

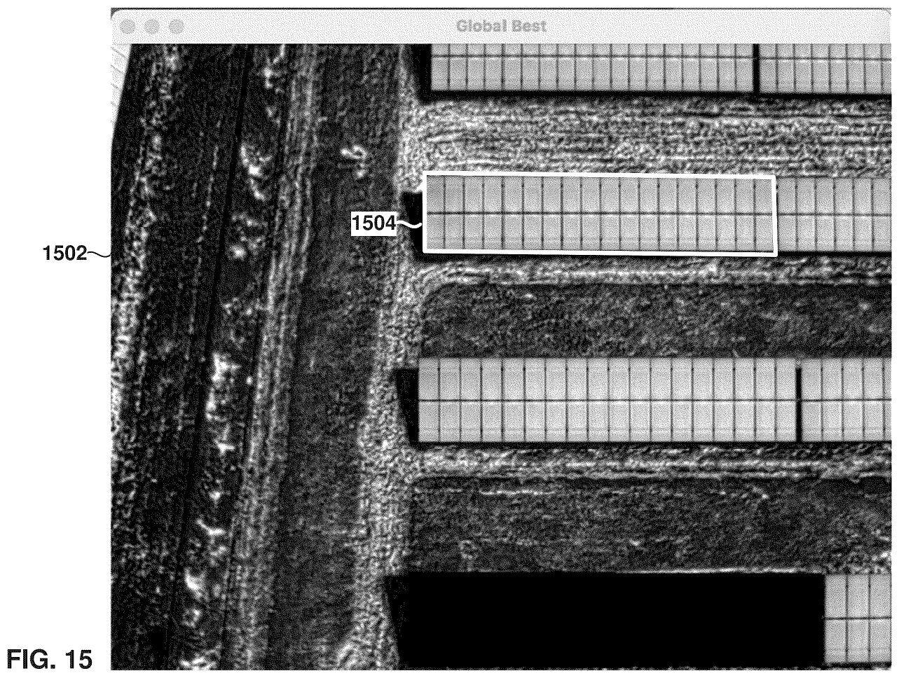

FIG. 13 shows image 1302 when running PSO again after removing one string from the image. FIG. 14 shows image 1402 with the particle's current positions after removing one string from the image. Further, FIG. 15 shows image 1502 with the identified mask 1504 for the string.

For each string/mask removed from the image, the string corner points are calculated. The string corner points are equal to the optimized x and y offsets plus the perspective padding, gap padding (for x values) and the x1, y1, x2, y2, x3, y3, x4, and y4 shifts.

The four corner points are then fed into a localization method, which takes the image metadata (drone altitude, latitude and longitude; flight pitch, yaw, roll; and gimbal pitch, yaw, and roll) to convert the corner point pixel locations in the image to actual refined latitude and longitudes which can then be used to specify the locations of each string at a solar farm.

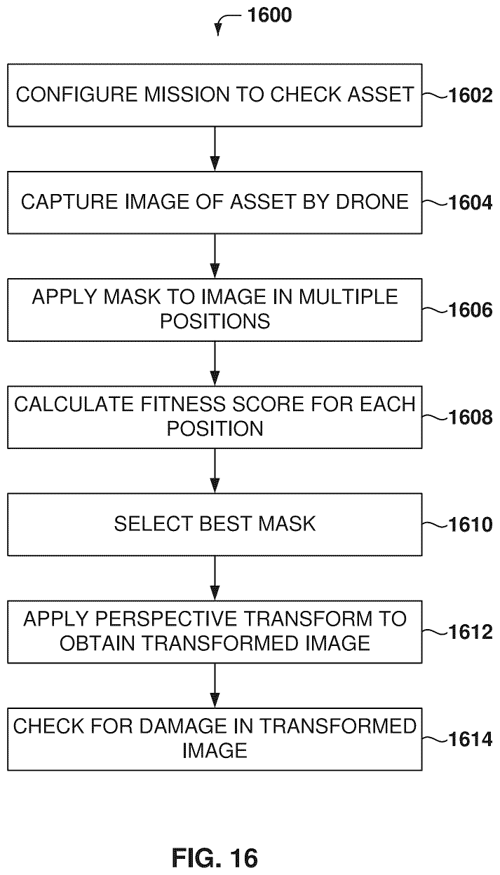

FIG. 16 is a flowchart of a method 1600 for asset inspection, according to some example embodiments. While the various operations in this flowchart are presented and described sequentially, one of ordinary skill will appreciate that some or all of the operations may be executed in a different order, be combined or omitted, or be executed in parallel.

At operation 1602, a mission is configured to fly the drone and check an asset. Then, at operation 1604, the drone captures one or more images of the asset.

After the image is taken, an optimization method is used to determine the location of the asset in the image, including parameters to compensate for the perspective view or a slight deviation of the location of the asset from the expected location (e.g., a solar panel has rotated to increase solar view). In some example embodiments, the method to find the five coordinates is a mathematical optimization algorithm to obtain the best match of the image pixels.

Mathematical optimization or mathematical programming is the selection of a best element, with regard to some criterion, from some set of available alternatives. In the more general approach, an optimization problem consists of maximizing or minimizing a real function by systematically choosing input values from within an allowed set and computing the value of the function. Generally, optimization includes finding “best available” values of some objective function given a defined domain (or input), including a variety of different types of objective functions and different types of domains.

In some example embodiments, the optimization process is for selecting a mask that maximizes the number of pixels that match the expected value (e.g., light or dark pixel).

Some algorithms are iterative methods that converge to a solution, or heuristics that may provide approximate solutions to some problems. There is a long list of optimization algorithms, such as hill-climbing methods, gradient-descent methods, particle swarm, Covariance Matrix Adaptation Evolution Strategy (CMA-ES), differential evolution, etc. The embodiment illustrated is for utilizing a particle swarm method, but other methods may be utilized.

In one example embodiment, the candidate solutions include candidate values for the 12 parameters searched in the case of the solar string. At operation 1606, at least one mask is applied to the captured image in multiple positions of the image. In one embodiment, the positive and the negative mask are used as described above. Other embodiments may utilize only the positive mask or the negative mask. Further, other embodiments may include more than two masks to be able to focus on different parts of the asset.

For solar string detection, the corner points and a transformation matrix are used to determine the alignment of the solar string related to the drone, and feed into the methods for geo-location and automated generation of solar site information for flight planning.

At operation 1608, a fitness score is calculated for each candidate, where the fitness score combines a fitness score for the positive mask and a negative score for the negative mask. The positive score indicates how well the positive mask works for masking the image by calculating the number of unmasked pixels that have a value within a predetermined range (e.g., the value of the pixel corresponds to dark pixels). The negative score indicates how well the native mask works for masking the image by calculating the number of unmasked pixels that have a value within a predetermined range (e.g., the value of the pixel corresponds to light pixels). For example, the more light pixels remaining in the target negative masked region, the higher the negative score.

In some embodiments, the distance of each pixel to the color white is calculated for the negative mask, and the distance of each pixel to black for the positive mask. Then the distances of all the pixels are added up to generate the score.

The positive score on the negative score may be combined in any form, such as calculating an average, but other methods may be utilized such as calculating a weighted average, a geometric average, etc. For example, in some cases, the black pixels are weighted higher than the light pixels because the black pixels provide more value when trying to find the boundaries of the solar string.

In one example for using color, the goal may be to find white and blue pixels that correspond to the solar string. One score may be calculated by calculating the distance from each pixel to the color blue, and another score may be calculated by calculating the distance from each pixel to the color white, after applying the respective masks for blue and white.

At operation 1610, the best mask (including the ten parameters) is selected based on the evaluated candidates. It is noted that operations 1606, 1608, and 1610 may be calculated in a loop, that is, one candidate at a time, and the loop will end once the desired threshold accuracy is obtained.

At operation 1612, a perspective transform is applied based on the calculated parameters for the selected mask to obtain an optimized image ready for analysis. The perspective transform transforms the captured image so the four selected corners form a rectangle. When human eyes see near objects, the objects look bigger as compared to those that are far away. This is called perspective. Perspective transformation converts images from the three-dimensional world into a two-dimensional image without perspective.

The optimized image of the solar string includes the panels of the solar string with the different panels, such as the 2×18 panels of FIG. 3. In some embodiments, an image then may be extracted for each separate solar panel by dividing the optimized image according to the 2×18 panel configuration. Thus, the damage analysis may be performed on the string as a whole, or on each panel individually.

Further, the metadata of the drone image includes the latitude and longitude of the image (e.g., top left location), of the latitude and longitude of the drone, as well as the viewing angle when the image was captured. From this metadata, it is possible to calculate the latitude and longitude of the solar string.

At operation 1614, a check for damage is performed based on the transformed image. For example, are there hotspots in the solar string, is there vegetation or another obstacle limiting the exposure to the sun, any broken panels, etc.

Image analysis may be performed to detect damage. In some example embodiments, image-recognition machine-learning models may be used to check for damage, such as neural networks. Because the analysis is performed on the exact location of the string, the analysis is more accurate than simply analyzing the drone-captured image. Further, the models may be smaller because of the accurate location of the solar panel. For example, if vegetation is obstructing the solar panel, the analysis of the complete image would have to determine if vegetation is over the panel or is part of the space between the strings. However, when analyzing the exact location of the string, if vegetation is found, it is because the vegetation is obstructing the view of the sun.

Finding hotspots on the panel may be simply detected by determining if some pixels (in the thermal image) in the solar cell are significantly hotter or colder than the majority of the pixels in the string. This may be determined by using a threshold difference between each pixel and the average of all the pixels. This operation may be performed with a simple algorithm that checks the temperature of the pixels, or by a small neural network.

The advantage of using masks is that it is possible to start asset damage detection without requiring training data. Also, the computer vision methodologies for solar damage detection are more accurate than simply image analysis of the whole image, right from the start without requiring training data.

As discussed above, the process determines the latitudes and longitudes of the asset, and when problems are found, the latitude and longitudes of the trouble spots are also determined with great accuracy. Thus, it is possible to report something like, “there is a problem in string 27, third panel on first row, with coordinates (x, y).” Also, the data may be stored for multiple missions over time, so showing images with the evolution of the problem is straightforward.

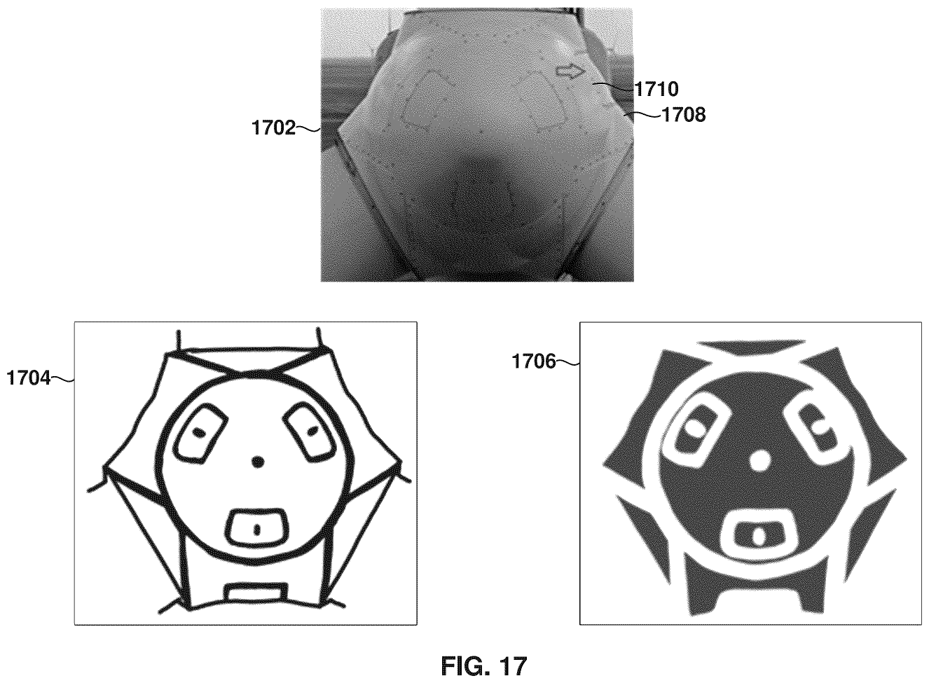

FIG. 17 illustrates a sample image 1702 of a spinner 1708 of a wind turbine with a positive mask 1706 and a negative mask 1704, according to some example embodiments. Similar methodology described above for solar panels may be used for the wind turbine.

Analysis parameters for the wind turbine include the current rotation of the spinner 1708 and the identification of the blades (e.g., blades 1 to 3). The rotation parameter indicates the angle for each blade in the image, where the blades are separated by 120°. For example, the analysis may indicate angles of 13°, 133°, and 253° for the blades.

In general, one, two or multiple masks can be used to extract the objects of interest from the image. The optimization finds the place where the object is and how to distort the object in the image, if needed, due to perspective.

In the illustrated example, to determine which blade is blade 1/A on a turbine (e.g., a Vestas V120 turbine) one or two masks are generated. The negative mask 1704 is where pixels are desired after performing edge detection, and the positive mask 1706 is where pixels are not desired after performing the edge detection.

Blade assignment is important to be able to distinguish the different blades in the turbine and follow their evolution over time, so when inspections are performed over time, it is useful to know how the blade looked previously (e.g., last year. The problem is that the location of the blade changes over time, so it's not possible to say straightforward from the image which blade is which.

In some turbines, there is a hatch 1710 on the spinner 1708, so by identifying where the hatch 1710 is in the spinner 1708, it is possible to determine the rotation of the spinner 1708.

The optimization process then finds the location of the spinner 1708 in the wind turbine and its rotation, by maximizing how many edge detection pixels are in the positive mask, and by minimizing how many edge detection pixels are in the negative mask.

In the optimization process, the rotation is an additional parameter to the 12 parameters discussed above. The process is the same, the candidate masks are placed on the image and the fitness calculated until the best mask is found.

Once the parameters are identified, the pixels of interest are extracted from the sample image 1702 to analyze the status of the turbine, such as possible damage, obstruction, etc.

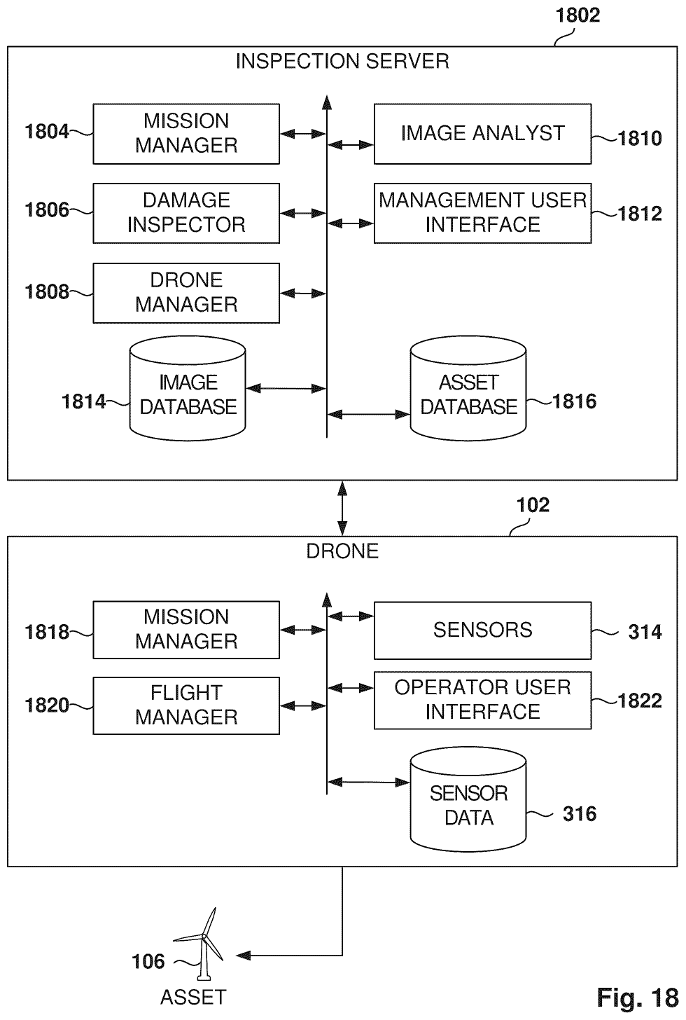

FIG. 18 illustrates a sample architecture for implementing example embodiments. The inspection server 1802 includes a mission manager 1804, a damage inspector 1806, a drone manager 1808, an image analyst 1810, a management user interface 1812, an image database 1814, and an asset database 1816.

The mission manager 1804 handles the operation-related activities, such as scheduling drones and configure missions. The damage inspector 1806 performs analysis on the extracted asset pixels to determine damage. Further, the drone manager 1808 interacts with the drones that will be flying to the assets.

The image analyst 1810 analyzes the drone-captured images to find the masks for extracting the asset pixels. The management user interface 1812 provides options for configuring asset-management activities, such as drone configuration, flight paths, expected asset location, etc.

The image database 1814 stores the images of assets captured by the drones or other equipment, and the asset database 1816 stores information about the assets 106, such as location and results from previous inspections.

The drone 102 includes a mission manager 1818, a flight manager 1820, sensors 314, an operator user interface 1822, and a sensor-data database 316.

The mission manager 1818 handles the different aspects of the mission and provides the operator user interface 1822 for interacting with the operator before the drone takes off for the mission. The flight manager 1820 interacts with the drone hardware to specify routes, altitudes, where to stop to take images, etc.

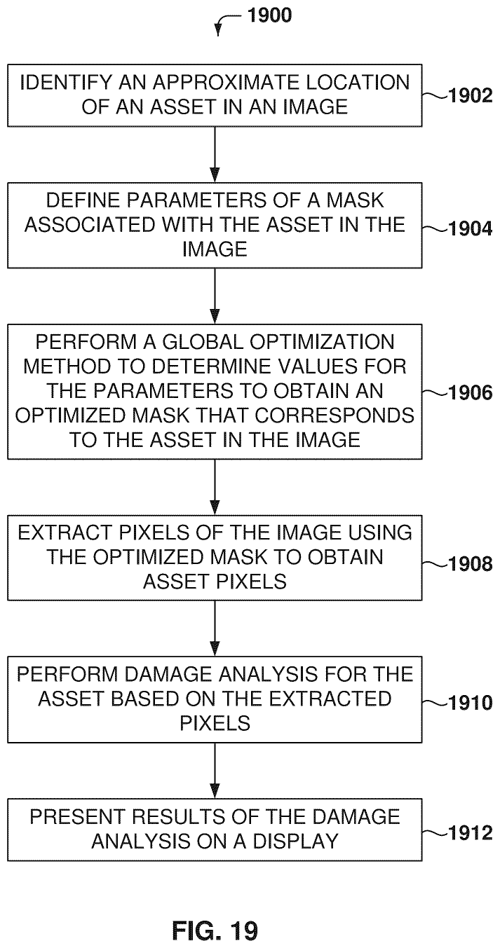

FIG. 19 is flowchart of a method 1900 for inspecting an asset using drone imagery, according to some example embodiments. While the various operations in this flowchart are presented and described sequentially, one of ordinary skill will appreciate that some or all of the operations may be executed in a different order, be combined or omitted, or be executed in parallel.

Operation 1902 is for identifying an approximate location of an asset in an image.

From operation 1902, the method 1900 flows to operation 1904 to define parameters of a mask associated with the asset in the image.

From operation 1904, the method 1900 flows to operation 1906 for performing a global optimization method to determine values for the parameters to obtain an optimized mask that corresponds to the asset in the image.

From operation 1906, the method 1900 flows to operation 1908 where pixels of the image are extracted using the optimized mask to obtain asset pixels.

From operation 1908, the method 1900 flows to operation 1910 for performing damage analysis for the asset based on the extracted pixels,

From operation 1910, the method 1900 flows to operation 1912 to present results of the damage analysis on a display.

In one example, the parameters comprise: horizontal offset and vertical offset of a top right corner in the image, horizontal shift for four corner locations of the mask, and vertical shift for the four corner locations of the mask.

In one example, the asset is a string of solar panels, and the parameters further comprise a panel width adjustment, and a panel height adjustment.

In one example, the method 1900 further comprises extracting pixels for each of the panels in the string of solar panels, wherein performing damage analysis for the asset comprises performing damage analysis for each panel based on the extracted pixels for the panel.

In one example, the asset is wind turbine, where the parameters further comprise a rotation angle of the wind turbine.

In one example, extracting pixels of the image further comprises performing a bitwise logical AND between corresponding pixels in the image and the mask.

In one example, the global optimization method is a particle swarm optimization based on hill climbing.

In one example, the method 1900 further comprises, before identifying the approximate location of the asset, capturing the image the asset with an autonomous drone.

In one example, identifying the approximate location of the asset comprises determining the approximate location of the asset based on a location of the drone when taking the image.

In one example, performing damage analysis comprises: calculating an average pixel value of the pixels in the asset, and determining pixels that deviate a predetermined amount from the average pixel value.

Another general aspect is for a system that includes a memory comprising instructions and one or more computer processors. The instructions, when executed by the one or more computer processors, cause the one or more computer processors to perform operations comprising: identifying an approximate location of an asset in an image; defining parameters of a mask associated with the asset in the image; performing a global optimization method to determine values for the parameters to obtain an optimized mask that corresponds to the asset in the image; extracting pixels of the image using the optimized mask to obtain asset pixels; performing damage analysis for the asset based on the extracted pixels; and presenting results of the damage analysis on a display.

In yet another general aspect, a tangible machine-readable storage medium (e.g., a non-transitory storage medium) includes instructions that, when executed by a machine, cause the machine to perform operations comprising: identifying an approximate location of an asset in an image; defining parameters of a mask associated with the asset in the image; performing a global optimization method to determine values for the parameters to obtain an optimized mask that corresponds to the asset in the image; extracting pixels of the image using the optimized mask to obtain asset pixels; performing damage analysis for the asset based on the extracted pixels; and presenting results of the damage analysis on a display.

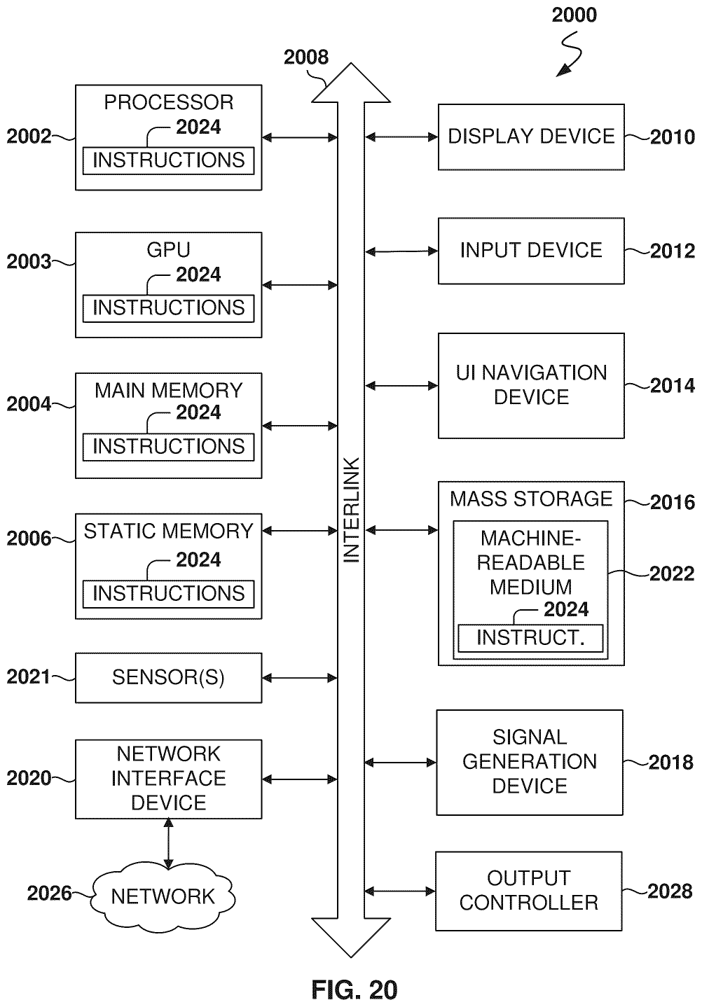

FIG. 20 is a block diagram illustrating an example of a machine 2000 upon or by which one or more example process embodiments described herein may be implemented or controlled. In alternative embodiments, the machine 2000 may operate as a standalone device or may be connected (e.g., networked) to other machines. Ina networked deployment, the machine 2000 may operate in the capacity of a server machine, a client machine, or both in server-client network environments. In an example, the machine 2000 may act as a peer machine in a peer-to-peer (P2P) (or other distributed) network environment. Further, while only a single machine 2000 is illustrated, the term “machine” shall also be taken to include any collection of machines that individually or jointly execute a set (or multiple sets) of instructions to perform any one or more of the methodologies discussed herein, such as via cloud computing, software as a service (SaaS), or other computer cluster configurations.

Examples, as described herein, may include, or may operate by, logic, various components, or mechanisms. Circuitry is a collection of circuits implemented in tangible entities that include hardware (e.g., simple circuits, gates, logic). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits) including a computer-readable medium physically modified (e.g., magnetically, electrically, by moveable placement of invariant massed particles) to encode instructions of the specific operation. In connecting the physical components, the underlying electrical properties of a hardware constituent are changed (for example, from an insulator to a conductor or vice versa). The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine 2000 (e.g., computer system) may include a hardware processor 2002 (e.g., a central processing unit (CPU), a hardware processor core, or any combination thereof), a graphics processing unit (GPU 2003), a main memory 2004, and a static memory 2006, some or all of which may communicate with each other via an interlink 2008 (e.g., bus). The machine 2000 may further include a display device 2010, an alphanumeric input device 2012 (e.g., a keyboard), and a user interface (UI) navigation device 2014 (e.g., a mouse). In an example, the display device 2010, alphanumeric input device 2012, and UI navigation device 2014 may be a touch screen display. The machine 2000 may additionally include a mass storage device 2016 (e.g., drive unit), a signal generation device 2018 (e.g., a speaker), a network interface device 2020, and one or more sensors 2021, such as a Global Positioning System (GPS) sensor, compass, accelerometer, or another sensor. The machine 2000 may include an output controller 2028, such as a serial (e.g., universal serial bus (USB)), parallel, or other wired or wireless (e.g., infrared (IR), near field communication (NFC)) connection to communicate with or control one or more peripheral devices (e.g., a printer, card reader).

The mass storage device 2016 may include a machine-readable medium 2022 on which is stored one or more sets of data structures or instructions 2024 (e.g., software) embodying or utilized by any one or more of the techniques or functions described herein. The instructions 2024 may also reside, completely or at least partially, within the main memory 2004, within the static memory 2006, within the hardware processor 2002, or within the GPU 2003 during execution thereof by the machine 2000. In an example, one or any combination of the hardware processor 2002, the GPU 2003, the main memory 2004, the static memory 2006, or the mass storage device 2016 may constitute machine-readable media.

While the machine-readable medium 2022 is illustrated as a single medium, the term “machine-readable medium” may include a single medium, or multiple media, (e.g., a centralized or distributed database, and/or associated caches and servers) configured to store the one or more instructions 2024.

The term “machine-readable medium” may include any medium that is capable of storing, encoding, or carrying instructions 2024 for execution by the machine 2000 and that cause the machine 2000 to perform any one or more of the techniques of the present disclosure, or that is capable of storing, encoding, or carrying data structures used by or associated with such instructions 2024. Non-limiting machine-readable medium examples may include solid-state memories, and optical and magnetic media. In an example, a massed machine-readable medium comprises a machine-readable medium 2022 with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 2024 may further be transmitted or received over a communications network 2026 using a transmission medium via the network interface device 2020.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Additionally, as used in this disclosure, phrases of the form “at least one of an A, a B, or a C,” “at least one of A, B, and C,” and the like, should be interpreted to select at least one from the group that comprises “A, B, and C.” Unless explicitly stated otherwise in connection with a particular instance, in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computer-implemented method comprising:
identifying an approximate location of an asset in an image;
defining parameters of a mask associated with the asset in the image;
performing a global optimization method to determine values for the parameters to obtain an optimized mask that corresponds to the asset in the image;
extracting pixels of the image using the optimized mask to obtain asset pixels;
performing damage analysis for the asset based on the extracted pixels; and
presenting results of the damage analysis on a display.

2. The method as recited in claim 1, wherein the parameters comprise:
horizontal offset and vertical offset of a top right corner in the image;
horizontal shift for four corner locations of the mask; and
vertical shift for the four corner locations of the mask.

3. The method as recited in claim 2, wherein the asset is a string of solar panels, wherein the parameters further comprise a panel width adjustment, and a panel height adjustment.

4. The method as recited in claim 3, the method further comprising:
extracting pixels for each of the panels in the string of solar panels, wherein performing damage analysis for the asset comprises performing damage analysis for each panel based on the extracted pixels for the panel.

5. The method as recited in claim 2, wherein the asset is wind turbine, wherein the parameters further comprise a rotation angle of a spinner in the wind turbine.

6. The method as recited in claim 1, wherein extracting pixels of the image further comprises:
performing a bitwise logical AND between corresponding pixels in the image and the mask.

7. The method as recited in claim 1, wherein the global optimization method is a particle swarm optimization based on hill climbing.

8. The method as recited in claim 1, further comprising:
before identifying the approximate location of the asset, capturing the image the asset with an autonomous drone.

9. The method as recited in claim 8, wherein identifying the approximate location of the asset comprises:
determining the approximate location of the asset based on a location of the drone when taking the image.

10. The method as recited in claim 1, wherein performing damage analysis comprises:
calculating an average pixel value of the pixels in the asset; and
determining pixels that deviate a predetermined amount from the average pixel value.

11. A system comprising:
a memory comprising instructions; and
one or more computer processors, wherein the instructions, when executed by the one or more computer processors, cause the system to perform operations comprising:
identifying an approximate location of an asset in an image;
defining parameters of a mask associated with the asset in the image;
performing a global optimization method to determine values for the parameters to obtain an optimized mask that corresponds to the asset in the image;
extracting pixels of the image using the optimized mask to obtain asset pixels;
performing damage analysis for the asset based on the extracted pixels; and
presenting results of the damage analysis on a display.

12. The system as recited in claim 11, wherein the parameters comprise:
horizontal offset and vertical offset of a top right corner in the image;
horizontal shift for four corner locations of the mask; and
vertical shift for the four corner locations of the mask.

13. The system as recited in claim 12, wherein the asset is a string of solar panels, wherein the parameters further comprise a panel width adjustment, and a panel height adjustment.

14. The system as recited in claim 13, wherein the instructions further cause the one or more computer processors to perform operations comprising:
extracting pixels for each of the panels in the string of solar panels, wherein performing damage analysis for the asset comprises performing damage analysis for each panel based on the extracted pixels for the panel.

15. The system as recited in claim 12, wherein the asset is wind turbine, wherein the parameters further comprise a rotation angle of a spinner in the wind turbine.

16. A tangible machine-readable storage medium including instructions that, when executed by a machine, cause the machine to perform operations comprising:
identifying an approximate location of an asset in an image;
defining parameters of a mask associated with the asset in the image;
performing a global optimization method to determine values for the parameters to obtain an optimized mask that corresponds to the asset in the image;
extracting pixels of the image using the optimized mask to obtain asset pixels;
performing damage analysis for the asset based on the extracted pixels; and
presenting results of the damage analysis on a display.

17. The tangible machine-readable storage medium as recited in claim 16, wherein the parameters comprise:
horizontal offset and vertical offset of a top right corner in the image;
horizontal shift for four corner locations of the mask; and
vertical shift for the four corner locations of the mask.

18. The tangible machine-readable storage medium as recited in claim 17, wherein the asset is a string of solar panels, wherein the parameters further comprise a panel width adjustment, and a panel height adjustment.

19. The tangible machine-readable storage medium as recited in claim 18, wherein the machine further performs operations comprising:
extracting pixels for each of the panels in the string of solar panels, wherein performing damage analysis for the asset comprises performing damage analysis for each panel based on the extracted pixels for the panel.

20. The tangible machine-readable storage medium as recited in claim 17, wherein the asset is wind turbine, wherein the parameters further comprise a rotation angle of a spinner in the wind turbine.
